(19) United States
(12) Patent Application Publication
(10) Pub. No.: US 2001/0022310 A1
(43) Pub. Date: Sep. 20, 2001

(54) Pusher for a fluid-dispensing member, and a dispensing member including such a pusher

(76) Inventors: Firmin Garcia, Evreux (FR); Stephane Beranger, Le Neubourg (FR)

Correspondence Address: ROCKEY, MILNAMOW & KATZ, LTD., Two Prudential Plaza, Suite 4700, 180 North Stetson Avenue, Chicago, IL, 60601, US

(21) Appl. No.: 09/810,953

(22) Filed: Mar. 16, 2001

(30) Foreign Application Priority Data
Mar. 20, 2000 (FR) FR-00.03534

(51) Int. Cl. B67D 5/40

(52) U.S. Cl. 222/385

(57) ABSTRACT

A pusher for a dispensing member for dispensing a fluid, the pusher being depressed to actuate the dispensing member and to dispense the fluid, said pusher being provided with central fastening means for enabling trim to be fixed to it.

The present invention relates to a dispensing member for dispensing a fluid, and more particularly to a pusher making it possible to actuate such a dispensing member; The term “dispensing member” is used to designate a pump or a valve designed to be mounted on the neck of a container. For example, a pump comprises a piston mounted to move inside a pump chamber. The piston is, in general, mounted on the bottom end of an actuating rod provided with a pusher, the piston being moved in the chamber by depressing the pusher.

### BACKGROUND OF THE INVENTION

In general, the pusher is made of a molded plastics material. Its top end defines an abutment surface for receiving one or more fingers of one hand.

Since the pusher is a visible element of the pump, it is a major factor in the appearance of the pump, and therefore by the appearance of the dispenser as a whole. That is why it can be advantageous to style the pusher.

In the prior art, Document EP 0 274 877, for example, describes a pusher provided with a peripheral snap-fastening profile which is formed on the outside wall of the pusher and to which trim is snap-fastened.

### OBJECTS AND SUMMARY OF THE INVENTION

An object of the invention is to define other fixing means for fixing to trim.

Another object of the invention is to facilitate transforming the appearance of a pusher so that it can take on a wide variety of pleasing shapes as a function of the style that is to be given to the dispensing member and to the dispenser as a whole.

To this end, the present invention provides a pusher for a dispensing member for dispensing a fluid, the pusher being depressed to actuate the dispensing member and to dispense the fluid, said pusher being provided with central fastening means for enabling trim to be fixed to it. The pusher constitutes a standard basic element that it is very easy to decorate by fixing trim to said fastening means. The central fastening means may be in the form of a central recess into which the trim is engaged. The pusher may also be provided with peripheral fastening means, e.g. snap-fastening means, in the form of a snap-fastening bead or of snap-fastening teeth on the outside periphery of the pusher.

The spirit of the invention lies in the fact that a standard pusher is used that is provided with a plurality of snap-fastening means so that the widest possible variety of trim can be mounted on it.

The invention also provides a dispensing member, such as a pump or a valve including such a pusher.

### BRIEF DESCRIPTION OF THE DRAWING

The invention is described more fully below with reference to the accompanying drawing which shows two embodiments of the present invention by way of non-limiting example.

In the drawing:

FIG. 1 is a vertical cross-section view through a dispensing member incorporating a pusher of the invention; and

FIG. 2 is a cross-section view through a pusher of a second embodiment of the invention.

### MORE DETAILED DESCRIPTION

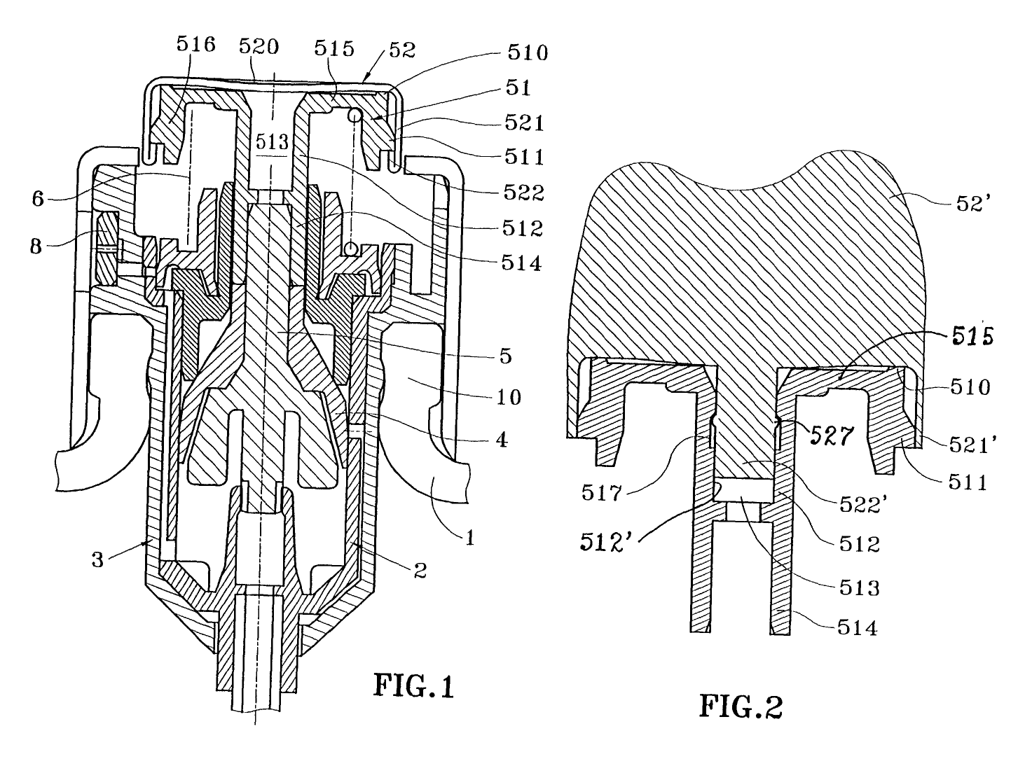

With reference firstly to FIG. 1, a dispensing member is shown mounted on a neck 10 of a container 1. The dispensing member shown is a pump but it could also be a valve. Conventionally, the pump comprises a pump body 2 inside which a piston 4 is slidably mounted on an actuating rod 5 underlying a pusher 51. To fix the body 2 in the neck 10, a fixing ring 3 is provided that cooperates with the inside wall of the neck 10. In the position shown in FIG. 1, the pump is in the rest position: the piston 4 is urged upwards by a return spring 6 which abuts against the pusher 51. By depressing the pusher 51, the spring 6 is compressed, and the piston is caused to descend inside the body 2 so as to reduce the volume of the pump chamber, and thus to deliver the fluid to the spray nozzle 8.

As shown in FIG. 1, the pusher 51 is thus mushroom or umbrella shaped. The pusher 51 includes a connection sleeve 514 which serves to connect the pusher to the actuating rod 5. Above the connection sleeve 514, the pusher defines a cylindrical portion 512 that forms a central engagement recess 513. Beyond this cylindrical portion 512, the pusher defines an annular horizontal flange 515. The annular flange 515 defines an abutment surface 510. A skirt 516 extends downwards from the outside periphery of the annular flange 515 and forms a snap-fastening bead or snap-fastening teeth 511.

In the invention, the pusher 51 is capped with trim 52 comprising an abutment surface 520 for receiving one or more fingers, a peripheral skirt 521 and an inwardly-facing turn-up 522 that co-operates with the snap-fastening teeth 511 of the pusher 51. To fix the trim 52 to the pusher 51, it is necessary merely to apply force to engage the trim 52 under the pusher 51 until the inwardly-facing turn-up comes into place below the teeth 511. The abutment surface 520 then comes into abutment against the abutment 510 formed by the pusher 51.

In this embodiment, the trim 52 co-operates with the periphery of the pusher 51 by snap-fastening onto said periphery.

With reference to FIG. 2, a second embodiment is shown which uses a pusher that is identical to the pusher shown in FIG. 1, but which implements trim that is different and that is in the form of dome 52′. This trim also includes a peripheral skirt 521′ which serves, in this example, merely to mask the pusher 51, but it may also serve to perform snap-fastening, as in FIG. 1. To fix the trim 52′ to the pusher 51, an engagement stud 522′ is provided, which stud is forced into the central recess 513 formed by the cylindrical portion 512.

The inside wall 512′ of the cylindrical portion 512 that defines the recess 513 may advantageously be provided with one or more notches 517. The stud 522′ on the trim 52′ may creep into said notch 517, thus improving the fastening of the stud in the recess 513. In a variant, the stud 522′ is provided with external projections 527 that are received in the notch 517. The trim is then snap-fastened into the recess via its stud 522′, and it also bears against the flange 515, thereby imparting excellent stability to it.

In the embodiments shown in FIGS. 1 and 2, the pusher does not incorporate a nozzle. However, the present invention is also applicable to a pusher incorporating a nozzle, e.g. at the trim 52′.

1. A pusher for a dispensing member for dispensing a fluid, the pusher being depressed to actuate the dispensing member and to dispense the fluid, said pusher being provided with central fastening means for enabling trim to be fixed to it.

2. A pusher according to claim 1, in which the central fastening means are engagement means.

3. A pusher according to claim 2, provided with a central engagement recess.

4. A pusher according to claim 3, in which the recess is provided with a cylindrical inside wall in which at least one notch is formed.

5. A pusher according to claim 4, in which the trim is provided with a stud that is forced into the recess.

6. A pusher according to claim 4, in which the stud is provided with external projections suitable for engaging in the notch.

7. A pusher according to claim 1, provided with peripheral fastening means suitable for co-operating with the trim, advantageously by snap-fastening.

8. A pusher according to claim 5, in which the recess is surrounded by an annular flange against which the trim abuts.

9. A pusher according to claim 1, provided with connection means for connecting it to an actuating rod provided with a piston.

10. A fluid-dispensing member including a pusher according to claim 1.
